(19) United States
(12) Patent Application Publication
(10) Pub. No.: US 2019/0363328 A1
(43) Pub. Date: Nov. 28, 2019

(54) Robust Reaction Metallurgical Joining

(71) Applicant: GM GLOBAL TECHNOLOGY OPERATIONS LLC, DETROIT, MI (US)

(72) Inventors: Hongliang Wang, Sterling Heights, MI (US); Sean R. Wagner, Shelby Township (US); Ryan C. Sekol, Grosse Pointe Woods (US); James G. Schroth, Troy (US)

(21) Appl. No.: 15/986,231

(22) Filed: May 22, 2018

(51) Int. Cl. H01M 2/26; B23K 11/087; B23K 11/20; B23K 11/31; B23K 11/36; B23K 20/16; H01M 2/20; H02G 5/02

(52) U.S. Cl. CPC H01M 2/26; B23K 11/087; B23K 11/20; B23K 11/312; B23K 2201/38; B23K 20/165; H01M 2/202; H02G 5/02; B23K 11/362

(57) ABSTRACT

A welded assembly and a method of reaction metallurgical welding are disclosed. The assembly includes a first metallic workpiece and a second metallic workpiece attached together by at least two overlapping weld joints. The overlapping weld joints are reaction metallurgically joined (RMJ) weld joints, and each overlapping weld joint overlaps with the other overlapping weld joint by 10-75%. The method of welding includes providing a reactive material between and in contact with the first and second workpieces. In a first position, the workpieces and the reactive material are pressed together, heated, and held between first and second tools to form a first RMJ weld joint between the workpieces. Then, in a second position, the workpieces are pressed together, heated, and held between the tools to form a second RMJ weld joint that overlaps with the first RMJ weld joint.

### TECHNICAL FIELD

This disclosure relates generally to welding processes, and more particularly to reaction metallurgical welding processes for joining workpieces of metal or metal alloys such as aluminum, copper, or alloys thereof.

### INTRODUCTION

The joining of metals such as aluminum alloys or copper alloys is complicated by the presence of rapidly forming oxide layers as well as their inherently high electrical and thermal conductivity. Resistance spot welding can be difficult and requires preparation of the workpiece surface, high currents, high forces, and mechanically well-aligned and stable electrodes. Short electrode life is common because of reaction between the aluminum workpiece alloy and the copper electrode or welding of the copper workpiece alloy to the copper electrode. Such interactions are greatest when welding thin workpieces because the electrode-workpiece contacts are brought close to the maximum temperature produced at the joining interface. The resultant weld between aluminum workpieces can have high strength, but poor high cycle fatigue performance under some conditions.

Lithium batteries for vehicle applications require a process to join the battery cells to a conductor or bus bar. The battery cells typically use thin aluminum and copper sheets as electrode substrates, also called current collectors. These electrode sheets incorporate an extension, known as a tab, which extends outside of the cell pouch and is used to join the electrode sheet to the copper conductors or bus bars during battery assembly. Two types of tab materials are commonly used in battery construction: aluminum and copper. In some cases, the copper tabs and/or copper conductor may be coated with a thin layer of nickel to enhance corrosion resistance and joining while aluminum tabs may be coated with an anodization layer.

Joining the thin tab materials to the much thicker copper conductor is difficult for several reasons. First, the stack-ups may require joining several separate pieces of metal in one operation, e.g., three separate tabs to one conductor. Second, one of the stack-ups includes a metal combination that is known to form brittle intermetallics, i.e., copper and aluminum may form CuAl₂. Third, the conductor bus is typically substantially thicker than the tabs, such as twice as thick or even five times as thick or greater.

Ultrasonic welding has been used for this application with some success. It enables the joining of dissimilar metals and is capable of joining materials with significant differences in sheet thickness. However, there is considerable difficulty in joining stack-ups that contain more than two sheets because the ultrasonic energy, i.e., vibrations parallel to the sheet surface, does not transfer well across multiple sheet-to-sheet interfaces. The top sheet couples well to the ultrasonic energy source because it is in direct contact with the ultrasonic horn or anvil. Hence it reacts strongly with the adjacent sheet. However, sheets located lower in the stack, including the conductor bar, do not receive as much ultrasonic energy, and the resulting weld may not be as strong.

Mechanical fasteners such as screws or rivets have also been used. They rely on very low contact resistance to achieve good electrical conductivity. However, contact resistance can degrade over time through the build-up of surface contaminants, e.g., oxides, or through degradation of the fastener.

Soldered joints can also be used. However, the use of solders with fluxing agents, particularly for aluminum, can result in the formation of corrosive flux residue that will degrade the surrounding materials or joint over time if not removed by cleaning operations. These operations add cost and, in some cases, may not be possible depending on the assembly sequence.

Reaction Metallurgical Joining (RMJ), a process outwardly similar to brazing under an applied load, may also be used. In the typical RMJ process, a joint is formed by placing a layer of a suitable reactive material between workpiece faying surfaces to be welded for the purpose of alloying with the faying surface material and forming a transient, movable, liquid-containing reaction product (often a eutectic or near-eutectic mixture) in-situ. The formation of this liquid-containing phase serves to remove oxides and other barriers to solid state welding at the intended weld interface. The interface region of the assembled workpieces is heated to form the mobile reaction product, but may be maintained at a temperature below the solidus temperature of one or both of the workpieces. In the process of serving its surface preparation function, the reaction product is squeezed from the interface, and the cleaned, heated, contacting surfaces are pressed together to form a weld joint that includes fusion welding of the workpieces near the reaction material interface. This process has proven effective in joining copper to copper with a lower melting point reaction material, in which case the copper workpieces remain solid and form a solid-state weld joint. It also applies to copper-aluminum joints with some notable differences. Due to the thin nature of the aluminum battery tab (on the order of 0.2 mm, for example), as well as its low melting temperature (660° C.) that is close to that of the reaction material, e.g. 600° C., the aluminum workpiece is completely melted, which leads to porosity and cracks in the joint and interaction of the aluminum liquid with the copper to form brittle intermetallic phases after solidification. In addition, at high heat inputs, the entire copper layer in contact with electrode may be dissolved by the liquid aluminum, which leads to sticking between the electrode and workpiece.

### SUMMARY

Partially overlapping RMJ weld joints allow an aluminum layer to be re-melted and reorganized to reduce the imperfections in the joint. The process may be used to join aluminum or copper workpieces (metals or alloys including nickel-plated copper) to other aluminum or copper workpieces.

In one form, which may be combined with or separate from other forms disclosed herein, a method of reaction metallurgical welding is provided. The method includes providing a metallic first workpiece, providing a metallic second workpiece, and providing a reactive material between and in contact with the first and second workpieces. Any desirable number of workpieces may be used in the stack up, with reactive material being disposed between each workpiece. The method further includes pressing the first and second workpieces (and any additional workpieces in the stack up) and the reactive material together between a first tool and a second tool in a first relative position of the tools and the workpieces. In the first relative position of the tools and the workpieces, the method includes heating the workpieces and the reactive material via the tools to form a reaction product that comprises a portion of the adjacent workpieces and the reactive material, and holding the workpieces together under pressure until the joint is cooled and a first reaction metallurgical joined (RMJ) weld joint is formed between teach workpiece. After heating the workpieces and the reactive material in the first relative position of the tools and the workpieces, the method includes pressing the workpieces and the reactive material together between the first tool and the second tool in a second relative position of the tools and the workpieces. The second relative position between the tools and the workpieces is different than the first relative position between the tools and the workpieces. In the second relative position of the tools and the workpieces, the method includes heating the workpieces via the tools, and holding the workpieces together until a second RMJ weld joint is formed between each workpiece, where the second RMJ weld joint overlaps with the first RMJ weld joint.

In another form, which may be combined with or separate from the other forms disclosed herein, a joined stackup assembly is provided that includes at least a metallic first workpiece and a metallic second workpiece, and may include any desired number of additional workpieces. The second workpiece is attached to the first workpiece by a plurality of overlapping RMJ weld joints. If additional workpieces are included, they are each attached to an adjacent workpiece. The overlapping weld joints are reaction metallurgically joined (RMJ) weld joints. Each overlapping RMJ weld joint overlaps with the other overlapping RMJ weld joint by 10-75%.

In yet another form, which may be combined with or separate from the other forms disclosure herein, a battery pack assembly is provided that includes a bus bar formed of a first metallic material and a battery tab formed of a second metallic material. The battery tab is attached to the bus bar by a plurality of overlapping reaction metallurgically joined (RMJ) weld joints. Each of the overlapping RMJ weld joints overlaps with another of the other overlapping RMJ weld joints by 10-75%.

In still another form, which may be combined with or separate from the other forms disclosed herein, a cantilever electrode system that includes first and second electrodes. The first electrode is configured to contact a first side of a workpiece stack-up, and the second electrode is configured to contact a second side of the workpiece stack-up in alignment with the first electrode. The first electrode has a first distal contact portion. The first distal contact portion has a first body and a first weld face supported on a distal end of the first body. A first proximal portion extends from the first distal contact portion. The second electrode has a second distal contact portion, the second distal contact portion having a second body and a second weld face supported on a distal end of the second body. A second proximal portion extends from the second distal contact portion. The first and second electrodes are configured to have a force applied to at least one of the first and second proximal portions along an offset axis that is offset from each of the distal contact portions.

Additional features may be provided, including but not limited to the following, alone or in combination: overlapping the first RMJ weld joint with the second RMJ weld joint by 10-75%; overlapping the first RMJ weld joint with the second RMJ weld joint by 10-50%; the first tool being a first electrode; the second tool being a second electrode; the steps of heating including energizing the first and second electrodes; the first electrode having a substantially flat end face; contacting a first zone of the first workpiece with the substantially flat end face of the first electrode while performing the step of heating the first and second workpieces and the reactive material in the first relative position; contacting a second zone of the first workpiece with the first electrode while performing the step of heating the first and second workpieces via the tools in the second relative position; the first and second zones overlapping; the first workpiece being formed of a first material; the second workpiece being formed of a second material; the first material being different than the second material; the first material being copper or a copper alloy; the second material being aluminum or an aluminum alloy; the first workpiece having nickel plating disposed on an outer surface of the first workpiece; attaching the reactive material to a faying surface of one of the first and second workpieces prior to heating the first and second workpieces; providing a metallic third workpiece; and the third workpiece being formed of copper or a copper alloy.

Further additional features may be provided, including but not limited to the following: providing a second reactive material layer between and in contact with the second and third workpieces; each reactive material layer having a lower melting point than a melting point of one or more of the first, second, and third workpieces; in the first relative position of the tools and the workpieces, pressing the second and third workpieces and the second reactive material layer together between the first tool and the second tool, heating the second reactive material layer and the third workpiece via the tools to form a second reaction product that comprises a portion of the second and third workpieces and the second reactive material layer, and holding second and third workpieces together until a third RMJ weld joint is formed between the second and third workpieces; in the second relative position of the tools and the workpieces, pressing the second and third workpieces together between the first tool and the second tool, heating the third workpiece via the tools, and holding the second and third workpieces together until a fourth RMJ weld joint is formed between the second and third workpieces; the fourth RMJ weld joint overlapping with the third RMJ weld joint; fully melting the second workpiece during at least one of the steps of heating the workpieces; the first workpiece being a first bus bar; the second workpiece comprising at least one battery tab; the third workpiece being a second bus bar; providing each of the first and second electrodes having a cantilever configuration wherein each electrode has a distal contact portion and a proximal portion extending from the distal contact portion; making contact between the distal contact portion of the first electrode and the first zone of the first workpiece; applying a force to the proximal portion of at least one of the first and second electrodes along an offset axis that is offset from each of the distal contact portions; the reactive material having a resistivity that is at least ten times greater than a resistivity of the second workpiece; the reactive material comprising aluminum, silicon, copper, phosphorus, silver, tin, nickel, and/or zinc; a metallic third workpiece being attached to the second workpiece by the overlapping RMJ weld joints; the battery tab having a first faying surface attached to the first bus bar; the battery pack assembly further comprising a second bus bar attached to a second faying surface, the second faying surface being part of one of the first battery tab and an additional battery tab; and the second bus bar being attached to the second faying surface by the overlapping RMJ weld joints.

The above and other advantages and features will become apparent to those skilled in the art from the following detailed description and accompanying drawings.

### BRIEF DESCRIPTION OF THE DRAWINGS

The drawings described herein are for illustration purposes only and are not intended to limit the scope of the present disclosure in any way.

FIG. 1 shows a schematic cross-sectional view of a stage in a process of reaction metallurgical welding, including disposing reactive material between a plurality of workpieces and positioning tools and the workpieces in a first relative position with respect to each other prior to applying heat, according to the principles of the present disclosure. The sizes of workpieces and reactive material are not necessarily drawn to scale.

FIG. 2 shows a schematic cross-sectional view of another stage in a process of reactional metallurgical welding, including forming reaction material between a plurality of workpieces by applying heat, according to the principles of the present disclosure. The sizes of workpieces and reactive material are not necessarily drawn to scale.

FIG. 2A shows a side view of a portion of an electrode for use with the reaction metallurgical welding process illustrated in FIGS. 1-2, in accordance with the principles of the present disclosure.

FIG. 3 shows a schematic cross-sectional view of yet another stage in a process of reaction metallurgical welding, including positioning the tools and the workpieces in a second relative position with respect to each other prior to applying heat a second time, according to the principles of the present disclosure. The sizes of workpieces and reactive material are not necessarily drawn to scale.

FIG. 4 shows a schematic cross-sectional view of still another stage in a process of reaction metallurgical welding, including forming reaction material between a plurality of workpieces by applying heat a second time, resulting in an overlapped weld joint, according to the principles of the present disclosure. The sizes of workpieces and reactive material are not necessarily drawn to scale.

FIG. 5 illustrates a plan view of an assembly after the process of reaction metallurgical welding is performed, in accordance with the principles of the present disclosure.

FIG. 6 is a perspective view of a plurality of overlapping RMJ weld joints formed between a battery tab and a conductor bus, according to the principles of the present disclosure.

FIG. 7 is a perspective view of a plurality of overlapping RMJ weld joints formed between at least one battery tab and a plurality of conductor buses, according to the principles of the present disclosure.

FIG. 8 is a perspective view of a plurality of cantilever tools for applying heat to a plurality of workpieces to form RMJ weld joints, which may incorporate the portion of the electrode shown in FIG. 2A, in accordance with the principles of the present disclosure.

### DETAILED DESCRIPTION

The present disclosure provides reaction metallurgical welding processes for joining metal or metal alloy workpieces. A reaction product comprising a mobile low-melting temperature liquid-containing material is temporarily formed between joining surfaces by applying heat with one or more tools. The mobile material is formed as a reaction product between the surfaces to be joined and a preplaced material selected specifically for its ability to react with the base metal alloys. Under the action of an applied force, the reaction product is displaced from the joint and leaves behind cleaned, substantially oxide-free aluminum or copper surfaces that, under continued pressure, form a metal-to-metal bond by virtue of fusion bonding at the reaction surface. Such a joint is referred to as a reaction metallurgically joined (RMJ) weld joint. The relative position between the tool(s) and the workpieces is then adjusted into a second position, and a second RMJ weld joint is formed that overlaps with the first RMJ weld joint by 10-75%. The application of heat for the second joint may result in re-melting and reorganization of the joint, which minimizes the pores and cracks, and thus improves the joint.

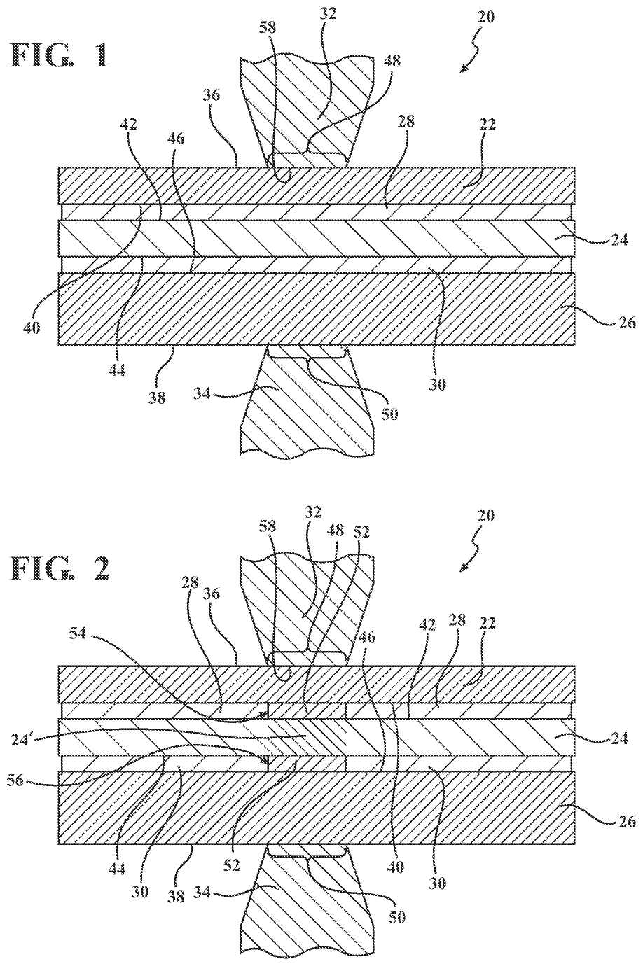

Referring now to FIG. 1, an assembly 20 is provided that includes a metallic first workpiece 22, a metallic second workpiece 24, and a metallic third workpiece 26, with a layer of reactive material 28 disposed between and in contact with the first and second workpieces 22, 24 and another layer of reactive material 30 disposed between and in contact with the second and third workpieces 24, 26. The reactive material 28, 30 is located between the intended bonding surfaces, or faying surfaces 40, 42, 44, 46, of the workpieces 22, 24, 26 to be RMJ welded.

In some examples, the first and third workpieces 22, 26 are made of copper or a copper alloy, and the second workpiece 24 is made of aluminum or an aluminum alloy. For example, the aluminum alloy may have an aluminum content of at least 85 wt %. However, in the alternative, the first or third workpieces 22, 26 could be made of aluminum, an aluminum alloy, steel, or any other suitable metallic material. Similarly, the second workpiece 24 could be made of copper, a copper alloy, steel, or any other suitable metallic material. In some variations, the first workpiece 22 may have a nickel-plating on an outer surface 36 and/or on an inner surface 40; and the third workpiece 26 may or may not have nickel-plating on an outer surface 38 and/or on an inner surface 46. In some examples, the second workpiece 24 may contain multiple sheets of metal, such as, for example, three aluminum or aluminum alloy thin sheets. Nickel plating could also be disposed on surfaces 42, 44 of the second workpiece 24.

The reactive material 28, 30 may be, for example, elemental copper, magnesium, aluminum, tin, nickel, silver, gold, and/or zinc, and may include other elements, such as silicon and/or phosphorus. Mixtures of these elements or alloys containing these elements may be used as the reactive material 28, 30. The reactive material 28, 30 preferably has a lower melting point than the workpieces 22, 24, 26 and a high electrical resistivity. The resistivity, which is dependent on the composition of the material, is a measure of inherent electrical resistance of a material. Applying a voltage to produce a preprogrammed current between the electrodes and across the workpieces and the reactive material 28, 30 produces a current therethrough, and the amount of energy generated through Joule heating, i.e. E=I²Rt, where E, I, R, and t are energy, current, electric resistance, and time, respectively, or the reactive material can be optimized by selecting a desired resistivity of the reactive material 28, 30, and/or selecting a desired geometry of the reactive material 28, 30. For example, a reactive material 28, 30 having a low resistivity will generate less energy than a reactive material 28, 30 having a high resistivity. Further, a reactive material 28, 30 having a high thickness will generate more energy than a reactive material 28, 30 having a low thickness. Yet further, a reactive material 28, 30 having a roughened surface texture may provide a generally lower contact area and therefore generally higher current intensity at points of contact than a similarly shaped reactive material 28, 30 having a generally smooth surface texture with an overall greater area of electrical contact.

In some examples, the reactive material 28, 30 may have a resistivity that is at least ten times that of aluminum or of one of the workpieces 22, 24, 26, or that is at least five times that of the combined resistivity of the joint formed between the workpieces 22, 24, 26 after they are RMJ welded together. In one example, the resistivity of each of the reactive layers 28, 30 may be at least 15 μΩcm, or in some cases, at least 26.5 μΩcm. The thickness of the reactive layer may be, for example, less than one tenth that of one of the workpieces 22, 24, 26.

The reactive material layers 28, 30 may have a particulate form, or may be formed of foils, wire, mesh or weaves, by way of example. Reactive material 28, 30 may be conveyed to the joint area manually or robotically as either a solid body or, particularly for particulate forms, entrained as a dispersion or a paste in a dispensable fluid which is either benign to the process or which will evaporate during processing. In some cases, the reactive material 28, 30 may be preplaced or attached to one of the faying surfaces 40, 42, 44, 46 of one of the workpieces 22, 24, 26 prior to performing the reaction metallurgical welding of the joint. In one example, the reactive material 28, 30 is ultrasonically welded to the one of the faying surfaces 40, 42, 44, 46 of one of the workpieces 22, 24, 26 prior to the RMJ welding of the workpieces 22, 24, 26.

To RMJ weld the workpieces 22, 24, 26 together, the workpieces 22, 24, 26 may be pressed together, with the reactive material 28, 30 therebetween, by fixtures, support blocks, or other objects (not shown), or by first and second tools 32, 34. The workpieces 22, 24, 26 may be subject to a pressure applied through the support blocks, tools 32, 34, or any other object that is pressing the workpieces 22, 24, 26 together. The pressure exerted on the workpieces 22, 24, 26 is sufficient to establish at least good mechanical contact between the contacting workpiece surfaces 40, 42, 44, 46 and the adjacent respective reactive material layer 28, 30.

The first tool 32 may be placed adjacent to an outer surface 36 of the first workpiece 22, and the second tool 34 may be placed adjacent to an outer surface 38 of the third workpiece 26. The first tool 32 is configured to apply current through a zone 48 of the first workpiece 22, and the second tool 34 is configured to pass the current through a zone 50 of the third workpiece 26 after it has passed through the intervening layers of 22, 28, 24, 30, 26.

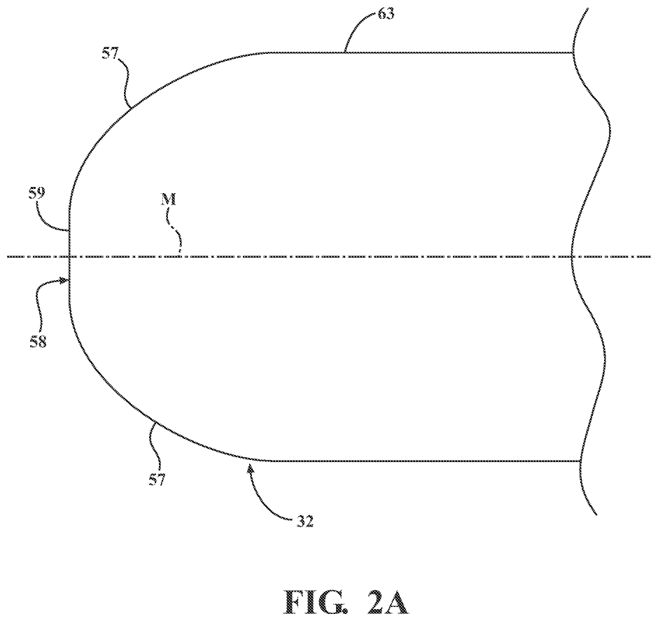

Referring to FIG. 2, the tools 32, 34 are used to apply current to the reactive material 28, 30, producing heat up to a process temperature, which leads reactive material 28, 30 to diffuse into, or otherwise interact with, the metallic compositions of the adjacent faying surfaces 40, 42, 44, 46 of the workpieces 22, 24, 26 to form a reaction product 52 between the first and second workpieces 22, 24 and between the second and third workpieces 24, 26 in areas aligned with the zones 48, 50. The reaction product 52 includes a low melting point liquid, incorporating the original reactive material 28, 30 and additional elemental components introduced by the reaction with and partial dissolution of the faying surfaces 40, 42, 44, 46 of the workpieces 22, 24, 26. This low melting temperature liquid may also comprise solid oxides and the like removed from the workpiece faying surfaces 40, 42, 44, 46. The application of current may also entirely melt an aluminum workpiece 24, such as indicated at 24′.

It will be appreciated that the reactive material 28, 30 may be selected to be of such an initial composition that the addition of alloying elements from workpieces 22, 24, 26 will not raise the solidus temperature of the reaction product 52 to a temperature greater than the maximum process temperature. However, the reactive material has a liquidus temperature that is preferably below the process temperature. More preferably, the addition of further elements to the reactive material 28, 30 to create the reaction product 52 will result in a further depression of the melting point of the reaction product 52 such as would be observed in a ternary, quaternary, or higher component eutectic alloy. Thus, at the process temperature of the applied heat, it is preferably that at least the outer workpieces 22, 26 remain unmelted, while the reactive material 28, 30 becomes liquid. The inner workpiece 24 may fully melt upon application of the heat, due to its thinness and low melting temperature.

The composition and shape of the reactive material 28, 30 (such as particles, wires, screens, sheets, films) may be selected to disrupt oxide films and other surface compositions on facing surfaces 40, 42, 44, 46 of the workpieces 22, 24, 26 to form the fluid liquid-containing reaction product 52. More rapid formation of reaction product 52 may be promoted by creating additional mechanical disruption of oxide films occurring between the assembled facing surfaces 40, 42, 44, 46 and interposed reactive material 28, 30, for example, by heating during preplacement of the reactive material 28, 30 on a faying surface 40, 42, 44, 46.

As a result of the applied pressure by the tools 32, 34 or other structure, the liquid-containing reaction product 52 may be partially expelled and squeezed out from the reaction zones 54, 56, and oxide at the faying surfaces 40, 42, 44, 46 will be removed by the displacement of the reaction product 52 through oxygen reduction reaction by the self-flux element, e.g., phosphorus, in the reactive material 28, 30, i.e. P+CuO/Cu₂O—>Cu+P₂O₅. A thin layer of molten reaction product 52 will still be present between oxide-free workpiece surfaces 40, 42, 44, 46, and hence a bond is generated in the reaction zones 54, 56 during solidification. However, in variations, the reaction product 52 is not substantially expelled until after another overlapping weld joint is made, which will be described in further detail below.

Alternatively, the joint configuration could be subjected to one applied pressure under which the reaction takes place and which substantially fully expels the reaction product 52. Or, rather than imposing a pressure, a displacement could be imposed that is sufficient to achieve the desired RMJ weld but intended to limit or minimize joint thinning. In some variations, features, such as depressions or recesses, could be formed in the faying surfaces 40, 42, 44, 46 of the workpieces 22, 24, 26, and discrete particles of reactive material 28, 30 may be embedded into such depressions or other features. This acts as a way of providing a uniform distribution of the reactive material 28, 30, where it may be more difficult with a smooth, featureless surface. When this workpiece is assembled against a second workpiece, the surfaces may initially engage the opposing joining surface. When the joining surfaces of the assembled workpieces are pressed together and the surfaces are heated, the reactive material may react with both workpiece surfaces to form a reaction product with its content of low melting point liquid. The workpiece surfaces 40, 42, 44, 46 would be uniformly consumed in this reaction to provide more surface area for the weld to be formed between the workpieces 22, 24, 26.

The foregoing description is intended to describe a process applicable to a wide range of workpieces. The metal element or alloy compositions of the reactive material are determined based on the composition(s) of the aluminum or copper metal or alloy(s) making up the joining surfaces of the respective workpieces and may be selected such that it satisfies certain criteria. For example, the solidus temperature of the reactive material 28, 30 (or individual component particle of a multi-component particle mixture) introduced into the gap between the workpieces 22, 24, 26 may be higher or lower than that of the workpieces 22, 24, 26, but the reactive material 28, 30, when reacted or alloyed with the workpieces 22, 24, 26, may be selected to generate an alloy (reaction product) which has a solidus temperature lower than that of one or more of the workpieces 22, 24, 26 so that a process temperature for forming the reaction product 52 will not lead to excessive workpiece softening. In addition, the reaction material 52, when molten, may wet the workpieces' faying surfaces 40, 42, 44, 46 in cleaning them of oxides and other impediments to the formation of a RMJ weld between the cleaned surfaces 40, 42, 44, 46. More preferably, the reaction material 52 will also wet the oxidized workpiece surfaces 40, 42, 44, 46 so that the molten alloy may spread and interact with the workpieces 22, 24, 26 over the entire pressurized joining region. Furthermore, the alloy formed at the conclusion of the process, when the maximum fraction of the workpieces 24, 22, 26 has been dissolved and when the alloy may incorporate particles of the pre-existing workpiece oxide, may have a viscosity such that it may be substantially fully expelled from the gap between the workpieces 22, 24, 26.

For coated materials, the quantity and composition of reactive material 28, 30 may be chosen to remove all of the coating, including any reaction products formed between the coating and the substrate of the workpieces 22, 24, 26. In some cases, it may be possible to remove only a part of the coating if the coating is thick enough or if the beneficial effects of the coating are desired in the bond. It will, of course be appreciated that the bond between the substrate and the coating must itself be capable of reaction metallurgical welding. As an example, for an anodized coating on aluminum, complete removal of the coating would be desired to effect the RMJ weld.

Heating may be accomplished using a variety of methods. For example, resistance heating may be used with support pads to pass a predetermined current for a predetermined time through the pressurized region. Alternatively, the support pads may be externally heated, for example by the incorporation of cartridge heaters (not shown) with reliance on conduction to convey the heat to the workpiece interfaces 40, 42, 44, 46, i.e., conductive heating. It may be feasible to incorporate induction coils to use induction heating. For these alternate heating methods, the electrical resistivity of the reactive material is no longer critical to process.

In one example, each of the first and second tools 32, 34 is provided as an electrode. Heating of the workpieces 22, 24, 26 and the reactive material 28, 30 is accomplished by energizing the first and second electrodes 32, 34 to pass a current through the workpieces 22, 24, 26 and through the reactive material 28, 30, which is referred to as resistive heating. Referring to FIG. 2A, with continued reference to FIGS. 1-2, in one example, one or both electrodes 32, 34 may be provided with a substantially flat end face 58. The end face 58, which may also be referred to as a weld face, is a portion of the respective electrode 32, 34 that is pressed against, and impressed into, the zone of contact (such as 48 or 50, or 62, 64 shown in FIG. 4) in the outer side 36, 38 of the workpiece 22, 26 to communicate electrical current during each instance the electrodes 32, 34 are operated to conduct RMJ welding. The end face 58 may be completely flat, or it may have a slight curvature, such as a radius of curvature up to 2 millimeters, by way of example. The substantially flat end face 58 may have a flat portion 59 disposed along an axis of movement M of the electrode 32. The flat portion 59 may have a small radius of curvature, as explained above. A curved surface 57 may extend from the flat end face 58 toward a cylindrical body portion 63 of the electrode 32. In the alternative, a frustoconical (tapered) transition nose connecting the substantially flat end face 58 to the cylindrical body portion 63.

A substantially flat end face 58 is particularly useful in applications where one of the outer workpieces 22, 26 has nickel plating, as the substantially flat end face 58 is resistant to sticking. Thus, in some examples, the electrodes 32, 34 contact the respective workpieces 22, 26 at the zones 48, 50, which may then be referred to as contact zones 48, 50. One or more of the electrodes 32, 34 could alternatively have a multi-ring domed (“MRD”) configuration, such as that shown and described in U.S. Patent Application Publication No. 2017/0297138, which is hereby incorporated by reference in its entirety, or an electrode 32, 34 may have any other desired end face 58. Each electrode 32, 34 may be formed of an electrically conductive material such as, for example, a copper alloy or a refractory metal.

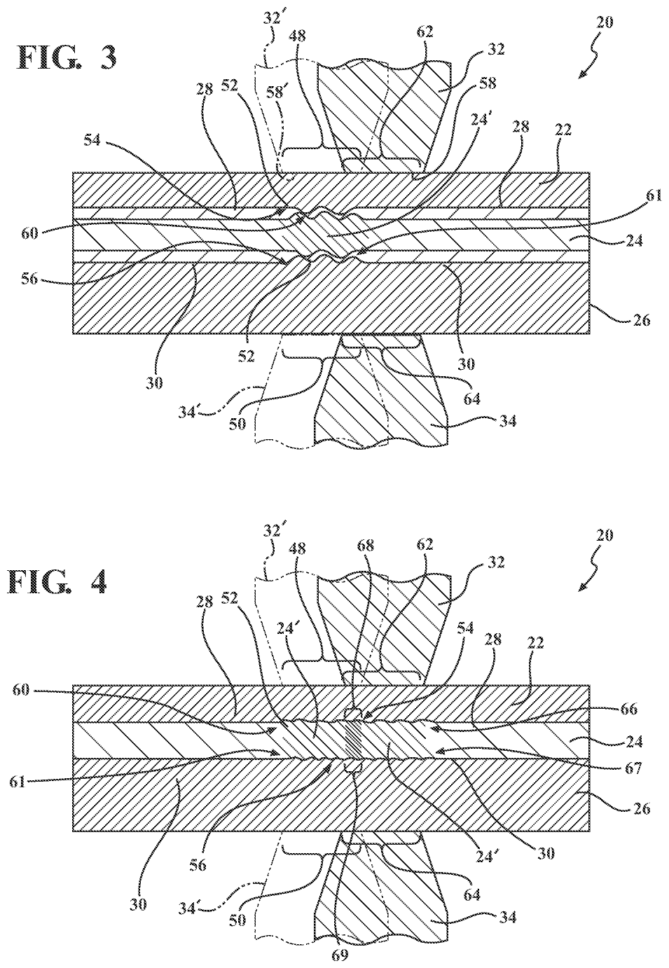

In sum, referring to FIG. 3, a first set of RMJ weld joints 60, 61 are formed by pressing the workpieces 22, 24, 26 and the reactive material 28, 30 together between the first and second tools 32, 34 (which may be electrodes) in a first relative position of the tools 32, 34 and the workpieces 22, 24, 26, heating the workpieces 22, 24, 26 and the reactive material 28, 30 via the tools 32, 34 to form the reaction product 52 that comprises a portion of the respective adjacent workpieces 22, 24, 26 and the reactive material 28, 30, and holding the workpieces 22, 24, 26 together until the first set of RMJ weld joints 60, 61 is formed between the faying surfaces 40, 42, 44, 46 of the respective workpieces 22, 24, 26. More particularly, one of the first RMJ weld joints 60 is formed at the inner face 40 of the first workpiece 22 and the adjacent face 42 of the second workpiece 24, and another of the first RMJ weld joints 61 is formed at the inner face 46 of the third workpiece 26 and the adjacent face 44 of the second workpiece 24.

Referring to FIG. 3, after heating the workpieces 22, 24, 26 and the reactive material 28, 30 in the first relative position of the tools 32, 34 and the workpieces 22, 24, 26 as shown in FIGS. 1-2, the tools 32, 34 and the workpieces 22, 24, 26 are placed into a second relative position with respect to each other. To this end, either the tools 32, 34 could be moved to a second position while the workpieces 22, 24, 26 are kept in a fixed position, or the workpieces 22, 24, 26 could be moved to a second position while the tools 32, 34 are kept in a fixed position, or both the workpieces 22, 24, 26 and the tools 32, 34 could be moved. In one example, in the second relative position, the first tool 32 is then arranged adjacent to (and in some cases, contacting) a second zone 62 of the first workpiece 22, and the second tool 34 is then arranged adjacent to (and in some cases, contacting) a second zone 64 of the third workpiece 26. The second zone 62 of the first workpiece 22 partially overlaps with the first zone 48 of the first workpiece 22; and similarly, the second zone 64 of the third workpiece 26 partially overlaps with the first zone 50 of the third workpiece 26. In some cases, in the alternative, the third workpiece 26 may be omitted and the zones 50, 64 contacted by the second tool 34 may be located on the second workpiece 24.

The second relative position between the tools 32, 34 and the workpieces 22, 24, 26 is shown in FIG. 3 with the tools 32, 34 being drawn with a solid line, and the first relative position between the tools 32, 34 and the workpieces 22, 24, 26 is shown in FIG. 3 with the tools being drawn with dashed lines and indicated at 32′ and 34′. Thus, the second relative position between the tools 32, 34 and the workpieces 22, 24, 26 is different than the first relative position between the tools 32, 34 and the workpieces 32, 34. In the first position, the first tool 32′ is aligned with the first zone 48 and may be contacting the first zone 48, and the second weld tool 34′ is aligned with the first zone 50 and may be contacting the first zone 50; while in the second relative position, the first tool 32 is aligned with the second zone 62 and may be contacting the second zone 62, and the second weld tool 34 is aligned with the second zone 64 and may be contacting the second zone 64. The first and second zones 48, 62 on the first workpiece 22 overlap with each other, and the first and second zones 50, 64 on the third workpiece 26 overlap with each other.

In this example, in the second relative position, prior to applying current, the zone 62 overlaps with a portion of unreacted reactive material 28 and a portion of reaction material 52 created by the first RMJ weld, and the zone 64 overlaps with a portion of unreacted reactive material 30 and a portion of reaction material 52 created by the first weld operation described above. Like the operation in the first relative position, in the second relative position, the first, second, and third workpieces 22, 24, 26, as well as any remaining reactive material 28, 30, are pressed together between the first tool and the second tool 32, 34. In the second relative position of the tools 32, 34 and the workpieces 22, 24, 26, the workpieces 22, 24, 26 are heated via the tools 32, 34 through the zones 62, 64. As such, reaction product, like the reaction product 52, will be further formed between the workpieces 22, 24, 26, as described above, at the portions of the faying surfaces 40, 42, 44, 46 that are aligned with the second position of the electrodes 32, 34.

Referring to FIG. 4, in the second relative position after heating, the workpieces 22, 24, 26 may then be held together until a second RMJ weld joint 66 is formed between the first and second workpieces 22, 24, where the second RMJ weld joint 66 overlaps with the first RMJ weld joint 60 at an overlapped joint portion 68. Similarly, in the second relative position after heating, the workpieces 22, 24, 26 are held together until a second RMJ weld joint 67 is formed between the second and third workpieces 24, 26, where the second RMJ weld joint 67 overlaps with the first RMJ weld joint 61 at an overlapped joint portion 69.

As a result of the applied pressure by the tools 32, 34 or other structure, the liquid-containing reaction product 52 may be partially or fully expelled from the reaction zones. Thus, in FIG. 4, the reaction material 52 is not shown, as it and the non-reacted reactive material 28, 30 has been pressed out of the interfaces between the faying surfaces 40, 42, 44, 46. However, in variations, the reaction product 52 may not be completely expelled.

The first RMJ weld joint 60 between the first and second workpieces 22, 24 may overlap with the second RMJ weld joint 66 between the first and second workpieces 22, 24 by 10-75%, or more preferably, by 10-50%. Similarly, the first RMJ weld joint 61 between the second and third workpieces 24, 26 may overlap with the second RMJ weld joint 67 between the second and third workpieces 24, 26 by 10-75%, or more preferably, by 10-50%.

Thus, in the illustrated example, the first tool, which is a first electrode 32, contacts the first zone 48 of the first workpiece 22 with the substantially flat end face 58 of the first electrode 32 while performing the step of heating the workpieces 22, 24, 26 and the reactive material 28, 30 via the tools 32, 34 in the first relative position. Then, in the second relative position, the first electrode 32 contacts the second zone 62 of the first workpiece 22 while performing the step of heating the workpieces 22, 24, 26 via the tools 32, 34 in the second relative position.

The second electrode 34 may contact the first zone 50 of the third workpiece 26 (or a first zone of the second workpiece 24 if the third workpiece 26 is omitted) while performing the step of heating the workpieces 22, 24, 26 and the reactive material 28, 30 in the first relative position. Then, in the second relative position, the second electrode 34 may contact the second zone 64 of the third workpiece 26 while performing the step of heating the workpieces 22, 24, 26 via the tools 32, 34 in the second relative position. The stack of workpieces 22, 24, 26 does not necessarily need to only have two or three workpieces, and in the alternative, four or more workpieces 22, 24, 26 may be stacked and reaction metallurgically welded as desired. In some cases, copper/copper alloy layers are interleaved with aluminum/aluminum alloy layers. In other cases, several aluminum/aluminum alloy tabs are provided as the second workpiece 24, which a copper/copper alloy workpiece on each end.

After applying current and pressure to effect the second RMJ weld joints 66, 67, the liquid-containing reaction product 52 may be partially or fully expelled from the reaction zones 54, 56, thereby enabling oxide-free workpiece surfaces 40, 42, 44, 46 to achieve intimate contact while still at operating temperature and hence generate a fusion bond in the reaction zones 54, 56 with remnant reaction product 52 at its periphery.

In some cases, the second workpiece 24 may be fully melted while the tools 32, 34 are heating the workpieces 22, 24, 26. In some examples, the aluminum/aluminum alloy second workpiece 24 is fully melted between the copper/copper alloy workpieces 22, 26 because the second workpiece 24 has a thickness in the range of about 0.15 mm to about 0.4 mm, which may be equal to or about equal to 0.2 mm. The fully melted portion is indicated at 24′

Thus, after performing the first and second overlapping RMJ welding steps, an assembly 20 results that includes at least two metallic workpieces 22, 24 (in this case, three metallic workpieces 22, 24, 26) attached together by a plurality of overlapping RMJ weld joints 60, 66, 61, 67, where each overlapping RMJ weld joint 60, 66, 61, 67 is a reaction metallurgically joined (RMJ) RMJ weld joint. As stated above, each overlapping RMJ weld joint 60, 62 overlaps with another of the overlapping RMJ weld joints 61, 67 by 10-75%, or by 10-50%.

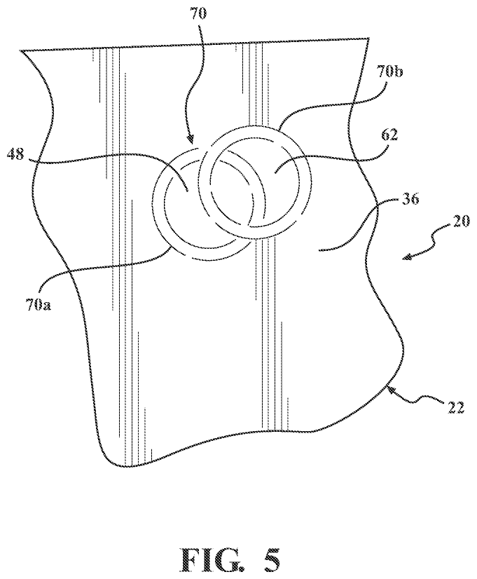

Referring to FIG. 5, an outer surface 36 of the assembly 20 is shown. The electrode 32 (shown in FIGS. 1-4) has created welding marks 70 in the outer surface 36 corresponding to the first and second relative positions between the workpiece 22 and the electrode 32. The electrode 32 has imprinted a first ring 70a around the first zone 48 and a second ring 70b around the second zone 62. As can be seen in FIG. 5, the first and second zones 48, 62 overlap. In one example, like the RMJ weld joints themselves, the first and second zones 48, 62 overlap by 10-75%, or by 10-50%.

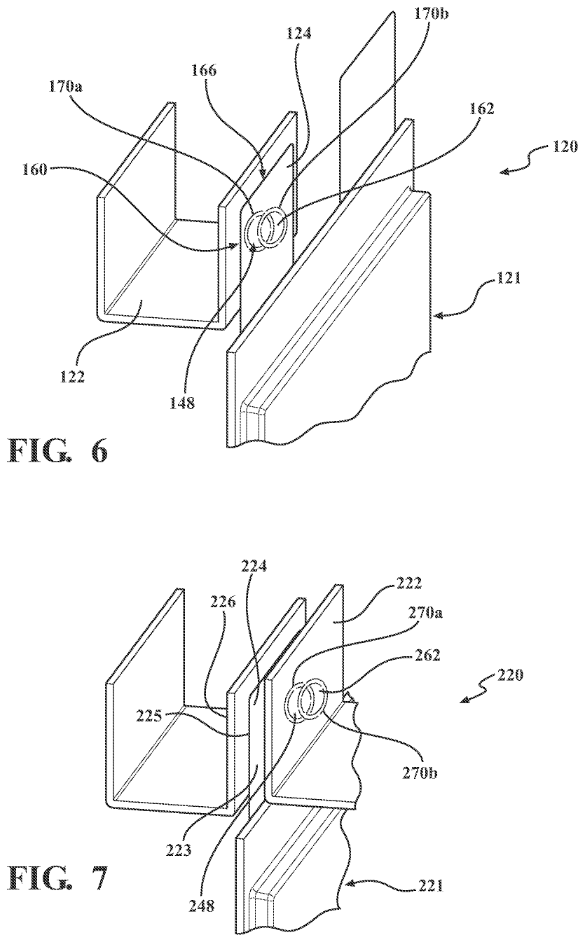

FIGS. 6-7 show the joining of multiple sheet layers (e.g., battery cell tabs) fabricated from aluminum or copper, or alloys thereof, to a heavier gauge copper sheet (e.g., conductor). Referring now to FIG. 6, a portion of a battery pack assembly is schematically illustrated and generally designated at 120. The battery pack assembly 120 has a plurality of battery cells 121 (one of which is shown in FIG. 6), and each battery cell 121 has an aluminum or aluminum alloy battery tab 124 extending from the battery cell 121. In some examples, multiple battery tabs 124 may extend from the battery cell 121. A bus bar 122 is disposed alongside the battery tab 124. The bus bar 122 may be formed of copper, a copper alloy, aluminum, or an aluminum alloy, by way of example. The battery tab 124 is attached to the bus bar 122 by a plurality of overlapping weld joints 160, 166, evidence of which is shown by overlapping zones 148, 162, which are respectively surrounded by first and second weld rings 170a, 170b. Each weld joint 160, 166 is a weld joint formed by reaction metallurgically joining, as described above. The overlapping weld joints 160, 166 overlap with one another by 10-75%, or in some cases, by 10-50%. The zones 148, 162 contacted by the electrode may also overlap by 10-75% or by 10-50%. The overlapping weld joints 160, 166 are preferably RMJ weld joints formed by placing reactive material between the faying surfaces of the bus bar 122 and the battery tab 124.

Though a single bus bar 122 is illustrated as being reaction metallurgically welded to one faying surface of the battery tab 124, it should be understood that a bus bar may be disposed on each side of the battery tab 124, with the battery tab 124 welded between the two bus bars, if desired. For example, referring to FIG. 7, a portion of another battery pack assembly is schematically illustrated and generally designated at 220. The battery pack assembly 220 has a plurality of battery cells 221 (one of which is shown in FIG. 7), and each battery cell 221 has a battery tab 224 (which may be formed of an aluminum or aluminum alloy) extending from the battery cell 221. First and second bus bars 222, 226 are disposed alongside opposing sides of the battery tab 224. The bus bars 222, 226 may be formed of copper, a copper alloy, aluminum, or an aluminum alloy, by way of example.

The battery tab 224 has a first faying surface 223 attached to the first bus bar 222, and the battery tab 224 has a second faying surface 225 attached to the second bus bar 226, where the second faying surface 225 is opposite the first faying surface 223. In other variations, the cell 221 has multiple battery tabs 224, such as three battery tabs 224 adjacent to each other, such that one of the three adjacent battery tabs 224 has the faying surface 223 attached to the first bus bar 222, and another of the three adjacent battery tabs 224 has the faying surface 225 attached to the second bus bar 226.

The battery tab (or tabs) 224 is attached to the bus bars 222, 226 by a plurality of overlapping weld joints. For example, overlapping zones 248, 262, which are respectively surrounded by first and second weld rings 270a, 270b, attach the first bus bar 222 to the battery tab 224. The zones 248, 262 may be the contact points by one of the electrodes or other heating tools (electrodes 32, 34 shown in FIGS. 1-4) that effects the RMJ weld joints between the tab 224 and each of the bus bars 222, 226.

Each weld joint between one of the bus bars 222, 226 and the battery tab 224 is a RMJ weld joint formed by reaction metallurgical joining, as described above. The overlapping weld joints between each of the bus bars 222, 226 and the battery tab 224 overlap with one another by 10-75%, or in some cases, by 10-50%. The zones 248, 262 may also overlap by 10-75% or by 10-50%. The overlapping weld joints 160, 166 are preferably RMJ weld joints formed by placing reactive material between the faying surfaces of the bus bars 222, 226 and the battery tab 224.

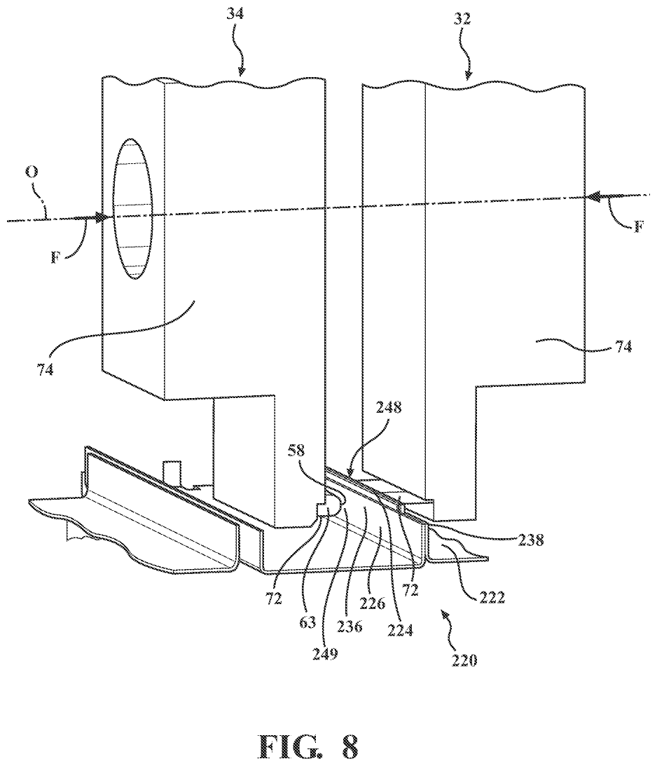

Referring now to FIG. 8, in one configuration, one or both electrodes 32, 34 may have a cantilever configuration wherein the electrodes 32, 34 form a cantilever electrode system. The first electrode 32 is configured to contact a first side 236 of a workpiece stack-up 220, and the second electrode 34 is configured to contact a second side 238 of the workpiece stack-up 220 in alignment with the first electrode 32.

Each electrode 32, 34 has a distal contact portion 72 and a proximal portion 74 extending from the distal contact portion 72. The distal contact portions 72 may make contact with the workpieces (in this case, the workpieces are the bus bars 222, 226, but in the alternative, other workpieces 22, 24, 26, 122, 124, 126 could be used). For example, the first electrode 32 makes contact with a first zone 248 of the first workpiece, or bus bar 222, and the second electrode 34 makes contact with a first zone 249 of the third workpiece, or bus bar 226. In one example, one or both of the distal end portions 72 may incorporate the cylindrical body 63 having the substantially flat end face 58 shown in FIG. 2A, and/or one or both of the distal end portions 72 may incorporate an MRD end face (not shown). Thus, the distal contact portions 72 may have a body 63 and a weld face 58 supported on a distal end of the body 63. The first and second electrodes 32, 34 are configured to have a force F applied to at least one of the first and second proximal portions 74 along an offset axis O that is offset from each of the distal contact portions 74. Thus, to perform the RMJ weld, a force F is applied to the proximal portions 74 of one or both of the first and second electrodes 32, 34 along the offset axis O. Accordingly, the distal contact portions 72 can be made smaller than otherwise, which allows them to be fit between adjacent bus bars.

A number of approaches to cooling the workpieces 22, 24, 26, 122, 124, 126, 222, 224, 226 following the creation of a joint between them may be adopted. Although reaction product 52 may still be molten at the conclusion of the process, it generally does not contribute to the joint strength, which is generally entirely attributable to the RMJ weld formed between substantially oxide-free faying surfaces 40, 42, 44, 46. Thus, the simplest procedure is to remove the joined workpieces 22, 24, 26, 122, 124, 126, 222, 224, 226 while still hot and allow them to air cool out of the tool. This may not be possible if the process temperature is so high that the hot joint is unable to support handling or gravitational loads on the part. In this case, the part could remain in the tools 32, 34 and air cool until the joint is strong enough. Alternatively, support plates (not shown) could be used to hold the workpieces 22, 24, 26, 122, 124, 126, 222, 224, 226 together, where the support plates incorporate cooling coils to circulate chilled water to extract heat more efficiently from the joint. The part could also or alternatively be subjected to enhanced cooling through air blast or water spray/mist cooling, or by water cooling through the electrodes 32, 34.

The detailed description and the drawings or figures are supportive and descriptive of the many aspects of the present disclosure. The elements described herein may be combined or swapped between the various examples. For example, the details described with respect to FIGS. 1-5 may be applied to the example shown in FIG. 6 or FIG. 7. While certain aspects have been described in detail, various alternative aspects exist for practicing the invention as defined in the appended claims.

1. A method of reactional metallurgical welding, the method comprising:
providing a metallic first workpiece;
providing a metallic second workpiece;
providing a reactive material between and in contact with the first and second workpieces;
pressing the first and second workpieces and the reactive material together between a first tool and a second tool in a first relative position of the tools and the workpieces;
in the first relative position of the tools and the workpieces, heating the first and second workpieces and the reactive material via the tools to form a reaction product that comprises a portion of the first and second workpieces and the reactive material, and holding the first and second workpieces together until a first reaction metallurgically joined (RMJ) weld joint is formed between the first and second workpieces;
after heating the first and second workpieces and the reactive material in the first relative position of the tools and the workpieces, pressing the first and second workpieces between the first tool and the second tool in a second relative position of the tools and the workpieces, the second relative position between the tools and the workpieces being different than the first relative position between the tools and the workpieces; and
in the second relative position of the tools and the workpieces, heating the first and second workpieces via the tools, and holding the first and seconds workpieces together until a second RMJ weld joint is formed between the first and second workpieces, the second RMJ weld joint overlapping with the first RMJ weld joint.

2. The method of claim 1, further comprising overlapping the first RMJ weld joint with the second RMJ weld joint by 10-75%.

3. The method of claim 1, further comprising overlapping the first RMJ weld joint with the second RMJ weld joint by 10-50%.

4. The method of claim 2, further comprising providing the first tool as a first electrode and providing the second tool as a second electrode, and the steps of heating including energizing the first and second electrodes to a pass a current through the first and second workpieces and the reactive material.

5. The method of claim 4, further comprising:
providing the first electrode having a substantially flat end face;
contacting a first zone of the first workpiece with the substantially flat end face of the first electrode while performing the step of heating the first and second workpieces and the reactive material in the first relative position; and
contacting a second zone of the first workpiece with the first electrode while performing the step of heating the first and second workpieces via the tools in the second relative position, the first and second zones overlapping.

6. The method of claim 1, further comprising:
providing the first workpiece as being formed of a first material;
providing the second workpiece as being formed of a second material, the first material being different than the second material.

7. The method of claim 6, the first material being one of copper and a copper alloy, the second material being one of aluminum and an aluminum alloy.

8. The method of claim 7, further comprising providing the first workpiece having nickel plating disposed on an outer surface of the first workpiece.

9. The method of claim 1, further comprising attaching the reactive material to a faying surface of one of the first and second workpieces prior to heating the first and second workpieces.

10. The method of claim 7, the reactive material being a first reactive material layer and the reaction product being a first reaction product, the method further comprising:
providing a metallic third workpiece, the third workpiece being formed of one of copper and a copper alloy;
providing a second reactive material layer between and in contact with the second and third workpieces, each reactive material layer having a lower melting point than a melting point of the first workpiece, each reactive material layer having a lower melting point than a melting point of the second workpiece, and each reactive material layer having a lower melting point than a melting point of the third workpiece;
in the first relative position of the tools and the workpieces, pressing the second and third workpieces and the second reactive material layer together between the first tool and the second tool, heating the second reactive material layer and the third workpiece via the tools to form a second reaction product that comprises a portion of the second and third workpieces and the second reactive material layer, and holding second and third workpieces together until a third RMJ weld joint is formed between the second and third workpieces; and
in the second relative position of the tools and the workpieces, pressing the second and third workpieces together between the first tool and the second tool, heating the third workpiece via the tools, and holding the second and third workpieces together until a fourth RMJ weld joint is formed between the second and third workpieces, the fourth RMJ weld joint overlapping with the third RMJ weld joint.

11. The method of claim 10, further comprising fully melting the second workpiece during at least one of the steps of heating the workpieces.

12. The method of claim 11, further comprising providing the first workpiece as a first bus bar, providing the second workpiece as at least one battery tab, and providing the third workpiece as a second bus bar.

13. The method of claim 5, further comprising:
providing each of the first and second electrodes having a cantilever configuration wherein each electrode has a distal contact portion and a proximal portion extending from the distal contact portion;
making contact between the distal contact portion of the first electrode and the first zone of the first workpiece; and
applying a force to the proximal portion of at least one of the first and second electrodes along an offset axis that is offset from each of the distal contact portions.

14. The method of claim 1, further comprising providing the reactive material having a resistivity that is at least ten times greater than a resistivity of the second workpiece, the method further comprising providing the reactive material comprising at least one of aluminum, silicon, copper, phosphorus, zinc, silver, tin, and nickel.

15. An assembly comprising:
a metallic first workpiece; and
a metallic second workpiece attached to the first workpiece by a plurality of overlapping weld joints, each overlapping weld joint being a reaction metallurgically joined (RMJ) weld joint, each overlapping weld joint overlapping with another overlapping weld joint of the plurality of weld joints by 10-75%.

16. The assembly of claim 15, the first workpiece being formed of one of copper and a copper alloy, and the second workpiece being formed of one of aluminum and an aluminum alloy.

17. The assembly of claim 16, further comprising a metallic third workpiece attached to the second workpiece by the plurality of overlapping weld joints, the third workpiece being formed of one of copper and a copper alloy.

18. The assembly of claim 15, wherein the first workpiece is a bus bar and the second workpiece is a battery tab.

19. The assembly of claim 18, the bus bar being a first bus bar and being formed of one of copper and a copper alloy, the second workpiece being formed of one of aluminum and an aluminum alloy, the battery tab having a first faying surface attached to the first bus bar, the battery pack assembly further comprising a second bus bar attached to a second faying surface, the second faying surface being a part of one of the first battery tab and an additional battery tab, the second bus bar being attached to the second faying surface by the plurality of overlapping RMJ weld joints.

20. A cantilever electrode system comprising:
a first electrode configured to contact a first side of a workpiece stack-up, the first electrode having:
a first distal contact portion, the first distal contact portion having a first body and a first weld face supported on a distal end of the first body; and
a first proximal portion extending from the first distal contact portion; and
a second electrode configured to be contact a second side of the workpiece stack-up in alignment with the first electrode, the second electrode having:
a second distal contact portion, the second distal contact portion having a second body and a second weld face supported on a distal end of the second body; and
a second proximal portion extending from the second distal contact portion,
wherein the first and second electrodes are configured to have a force applied to at least one of the first and second proximal portions along an offset axis that is offset from each of the distal contact portions.
